(19) United States
(12) Patent Application Publication
(10) Pub. No.: US 2022/0177341 A1
(43) Pub. Date: Jun. 9, 2022

(54) SEWAGE TREATMENT METHOD

(71) Applicant: EVOCRA PTY LIMITED, Tasmania (AU)

(72) Inventor: Michael DICKSON, Tasmania (AU)

(73) Assignee: EVOCRA PTY LIMITED, Tasmania (AU)

(21) Appl. No.: 17/442,142

(22) PCT Filed: Mar. 26, 2020
(86) PCT No.: PCT/AU2020/050290

§ 371 Date: Sep. 23, 2021

(30) Foreign Application Priority Data
Mar. 26, 2019 (AU) 2019901019

(51) Int. Cl. C02F 9/00; C02F 1/24; C02F 1/78; C02F 3/28; C02F 3/30; C02F 3/12

(52) U.S. Cl. CPC C02F 9/00; C02F 1/24; C02F 1/78; C02F 2101/36; C02F 3/30; C02F 3/12; C02F 3/28

(57) ABSTRACT

Disclosed herein is a method for remediating sewage that contains persistent contaminants. The method comprises ozofractionating the sewage under conditions whereby a foam fractionate comprising persistent contaminants is produced and separated from an ozofractionated wastewater, quiescing the ozofractionated wastewater, whereby a residual ozone content of the ozofractionated wastewater is reduced, and contacting the quiesced ozofractionated wastewater with a microorganism population under conditions effective to biologically remediate the ozofractionated wastewater.

### TECHNICAL FIELD

The present invention relates to methods for remediating sewage that contains persistent contaminants. In some forms of the invention, sewage and trade wastewater that contain persistent contaminants may be co-remediated.

### BACKGROUND ART

Water can be difficult to manage as it has the capacity to carry many substances that can potentially cause acute and chronic health impacts if ingested. These substances may be simple chemicals and pathogens associated with sewage, complex emerging and bio-accumulating persistent contaminants such as per- and poly-fluoroalkyl substances (PFAS) and microplastics, and other contaminants including pesticides such as dichlorodiphenyltrichloroethane (DDT), insecticides, pharmaceutical compounds and heavy metals.

Sewage treatment processes that use biological media to remediate domestic wastewaters are known and effective for removing many potentially harmful substances. As water testing has become more commonplace and sophisticated, however, there is an ever increasing awareness of widespread contamination of domestic wastewaters with persistent contaminants such as PFAS and microplastics. Removing some of these contaminants from the water can be challenging, especially given the enormous volume of domestic wastewaters that require treatment. For example, traditional activated sludge processes for remediating domestic sewerage have little effect on persistent contaminants such as PFAS and microplastics, with the contaminant either passing through the treatment process unaffected, or worse, becoming incorporated into the biological cultures, and subsequently the biosolids (e.g. dried and aged activated sludges).

Whilst techniques such as ion exchange or reverse osmosis can be used to adsorb contaminants such as PFAS and hence remove them from a water stream, they have significant practical limitations. For example, absorption capacity is a major issue for ion exchange and it is only effective for treating relatively low levels of contamination. Similarly, reverse osmosis membranes suffer from fouling, with increasingly demanding clean in place cycles being required during prolonged operation, and reject streams becoming an increasingly higher percentage of the total flow when the RO membrane is constantly exposed to PFAS and microplastics.

Ozofractionation is a technique that has been used by the present inventor to remediate industrial fluid wastes (e.g. contaminated ground, surface, sea, estuarine and industrial wastewaters) containing contaminants such as metals (e.g. mine wastewater) and persistent contaminants. During ozofractionation, the industrial fluid waste is exposed to tiny bubbles containing ozone which rise through the fluid towards the top of the ozofractionation chamber. Ozone diffuses out of the bubbles, where it decomposes to form oxygen and hydroxyl radicals. Both of these decomposition products are strong oxidants which can oxidise contaminant (and other) species within the chamber. Other contaminant species may adsorb to the surface of the ozone bubbles and form part of a foam fractionate which collects at the top of the ozofractionation chamber, where it may be separated.

Ozofractionation, in a much milder form, has also been used in aquaculture applications (in a technique known as protein skimming) and in sewage treatment processes. In sewage treatment processes, sewage is exposed to very mild ozofractionation conditions that are sufficient to oxidise some species in the sewage. This partially oxidises complex organic matter into smaller, less complex organic species which are more easily microbially digestible.

### SUMMARY OF INVENTION

In a first aspect, the present invention provides a method for remediating sewage that contains persistent contaminants. The method comprises ozofractionating the sewage under conditions whereby a foam fractionate comprising the persistent contaminants is produced and separated from an ozofractionated wastewater, quiescing the ozofractionated wastewater, whereby a residual ozone content of the ozofractionated wastewater is reduced, and contacting the quiesced ozofractionated wastewater with a microorganism population under conditions effective to biologically remediate the ozofractionated wastewater.

It was previously understood that exposing sewage to too much ozone would be extremely detrimental to the microbes essential to biological remediation processes. Ozone is, after all, one of the strongest known disinfecting agents. In light of such conventional wisdom, the inventor was extremely surprised to discover that pre-treating sewage using ozofractionation under the aggressive conditions required in order to separate persistent contaminants such as PFAS and microplastics does not affect downstream biological remediation (e.g. an activated sludge process) as adversely as thought. Indeed, ozofractionated wastewater, once allowed to quiesce, has been found by the inventor to be substantially free of dissolved ozone (it having been utilised by either partitioning into the foam fractionate or diffusing out through the bubbles and into the wastewater, where it decomposes via the reaction mechanisms described above) and surprisingly and unexpectedly aggressively biologically active. Thus, the inventor has discovered that ozofractionation involving relatively large quantities of ozone (i.e. as required to remediate wastewater including persistent contaminants) does not necessarily adversely affect a subsequent biological digestion. The inventor's discovery has resulted in the invention the subject of the present application, which has the potential to enable sewerage treatment plants to be capable of treating wastewaters that may be contaminated with a wide range of persistent and emerging contaminants.

The aggressive ozofractionation carried out in the method of the present invention provides a partitioning mechanism for separating many persistent contaminants out of the treatment stream, where they can be transferred to a dedicated remediation process, for example. Ozofractionation also converts long-chain complex hydrocarbons into short-chain non-complex and more biologically available species, and aggressively oxidises many contaminants, including persistent organic toxins and pharmaceuticals contaminations. Such oxidised contaminants are not necessarily separated with the foam fractionate but, if not, are usually in the form of species that are consistent with a remediated sewage. Ozofractionation may also assist in reducing total nitrogen and phosphorous and is known to resolve colour issues often present with humic substances in sewage streams.

Advantageously, the method of the present invention removes persistent contaminants from the sewage before the wastewater reaches the microorganism population. If this were not to occur, such contaminants may either pass through the treatment process unchanged or be taken up by the microorganisms during treatment of the wastewater, where they would contaminate the biological sludges. Either way, an effective remediation is not provided.

It is envisaged that the method of the present invention would, at least in some embodiments, be performed at centralised sewerage treatment plants, such as local or municipal sewage treatment plants. Using apparatus that can be retro-fitted at existing sewage treatment plants, the method of the present invention would provide for continuous partitioning of persistent contaminants such as PFAS and microplastics (etc.) out of the treatment stream, while enhancing the overall capacity of the plant due to its ability to tune the chemistry of the biological stages (primarily via the wastewater's oxidation reduction potential (ORP)) and dissolved oxygen (DO) for enhancing micro-organism efficiency in the later stage and continuous removal of colloidal sized particles.

In some embodiments, the method may further comprise maintaining the microorganism population whereby it remains effective to continuously biologically remediate the stream of ozofractionated wastewater. In such embodiments, additional microorganisms may, for example, be added in order to maintain an effective microorganism population. Such seeding of microorganisms would simply not be required in conventional sewerage treatment plants, as the incoming sewerage would provide a continual source of fresh microorganisms to maintain the population for the biological digestion stages.

In some embodiments, quiescing the ozofractionated wastewater may comprise allowing the ozofractionated wastewater to quiesce for a period of time whereby substantially all of the residual ozone in the ozofractionated wastewater is utilised (i.e. due to the processes and reactions described above). Such a quiescence may occur, for example, during transfer of the ozofractionated wastewater to the microorganism population.

In this manner, ozone from the ozofractionation stage does not pass into the biological remediation stage, and therefore does not adversely affect the health of the microorganism population, which would result in it becoming ineffective (or less effective) at biologically remediating the ozofractionated wastewater.

The ozofractionation to which the sewage is exposed (which will also be referred to herein as the primary ozofractionation) is aggressive, as is required in order to separate (i.e. partition) persistent contaminants from the wastewater. In some embodiments, ozofractionating the sewage may comprise exposing the sewage to an amount of ozone effective to increase the oxidation reduction potential (ORP) of the wastewater up to about 750 mV. In some embodiments, ozofractionating the sewage may comprise exposing the sewage to a foam of bubbles comprising ozone and having a size of less than about 200 μm. In some embodiments, ozofractionating the sewage may comprise exposing the sewage to an amount of ozone of between 5-150 mg/L/hour, depending on the ozone requirements to maintain a particular ORP set point.

In some embodiments, the ozofractionated wastewater may be contacted with a first microorganism population in a primary biological digestion, be that an anoxic, anaerobic or aerobic treatment. Such a primary treatment may, for example, occur in a primary clarifier, where solids can settle and undergo anaerobic digestion, with the relatively clear supernatant liquid being transferred to the next stage in the remediation process. In some embodiments, activated sludge which settles during the biological digestion may be recycled back into the wastewater pre-ozofractionation. The inventor notes that such recycling may beneficially ensure that biological cultures which generate a sludge that may be contaminated with any residual persistent chemicals in the ozofractionated wastewater (PFAS, for example, is known to accumulate in bacterial cell walls and hence in biosolids, and microplastics are known to deposit into biosolids) is not used as a fertilizer, as is often the case presently. Recycling this sludge back into the primary ozofractionation ensures that any entrained contaminants can be liberated and removed from solution.

In some embodiments, the method further comprises treating the wastewater after the primary biological digestion treatment to increase the ORP of the wastewater before further biological remediation. This may help to facilitate further contaminant removal and to manage the ORP for optimal culture conditions for biological remediation. Managing the wastewater's ORP such that it is within optimal range enables the highest efficiency of the biological cultures, which may help to biodegrade species in the wastewater faster or more completely.

In some embodiments, for example, the method may further comprise a secondary ozofractionation of the wastewater after the primary biological digestion. The secondary ozofractionation may be under conditions effective to manage/increase the ORP of the wastewater and result in the conversion of species in the wastewater into more easily digestible species that are more conducive to subsequent aerobic biodegradation (the ORP selected will depend on the required optimal conditions for subsequent biological digestion). As will be described in more detail below, breaking down long chain hydrocarbon molecules into smaller chain molecules significantly increases their biological digestibility. Any such secondary ozofractionation would be far less aggressive than the preliminary ozofractionation, primarily because of the risk of adversely affecting downstream microorganism populations, but also because the wastewater being ozofractionated would contain only a very small fraction (if any) persistent contaminants.

In embodiments of the present invention including such a secondary ozofractionation, the ozofractionation may comprise exposing the wastewater to an amount of ozone effective to increase the oxidation reduction potential (ORP) of the wastewater to between about 150 to 200 mV. Such conditions may be achieved, for example, by exposing the wastewater to an amount of ozone of about 0.5 mg/L/hour to about 5 mg/L/hour. In some embodiments, foam fractionate produced during the secondary ozofractionation (which may contain residual amounts of persistent contaminants) may be combined with the foam fractionate from the earlier (e.g. primary) ozofractionation (e.g. for destruction).

In some embodiments, the ozofractionated wastewater (either from the primary ozofractionation or the primary and secondary ozofractionations) may be biologically remediated in a biological digestion method such as an activated sludge process, a membrane bioreactor process, a membrane aerated bioreactor process, a trickle filter process, an algal suspension process, algal scrubbing process or a moving bed reactor process. In some embodiments, activated sludge produced during the biological remediation may be recycled back into the wastewater pre-ozofractionation (e.g. to further liberate entrained persistent contaminants such as PFAS and microplastics, as described above).

In some embodiments, the method may further comprise a tertiary ozofractionation, in which the biologically remediated wastewater is re-ozofractionated under conditions whereby any particulate material is captured in the foam fractionate for separation, with a portion of the re-ozofractionated wastewater optionally being recycled back into the microorganism population. Again, such a tertiary ozofractionation would be far less aggressive than the preliminary ozofractionation. The tertiary ozofractionation may, for example, comprise exposing the wastewater to an amount of ozone of about 0.00005 to about 0.005 mg/L/hour (and not more than required to maintain the ORP at a set point for the relevant chamber). The recirculation of ozofractionated wastewater having an ORP maintained at a specific set point can help to even further increase the efficiency of the biological remediation process.

Typically, the persistent contaminants contained in the foam fractionate or combined foam fractionates (e.g. from the primary and secondary and/or tertiary ozofractionations) are destroyed (e.g. using emerging technologies such as PFAS Harvesters or using conventional techniques such as sonolysis, heating or exposure to an extreme oxidation such as that described below). In some embodiments, the foam fractionate may be concentrated before the persistent contaminants are destroyed such that relatively smaller volumes of waste require processing.

In some embodiments, it may be necessary (or advantageous) to include a further step comprising subjecting the biologically remediated ozofractionated wastewater to a final treatment process (e.g. because of regulatory requirements regarding environmental discharge). Such a process may, for example, comprise disinfecting the biologically remediated ozofractionated wastewater.

In a second aspect, the present invention provides a method for co-remediating sewage that contains persistent contaminants and a trade wastewater that contains persistent contaminants. The method comprises:
ozofractionating the trade wastewater under conditions whereby a foam fractionate comprising persistent contaminants is produced and separated from an ozofractionated trade wastewater which contains an amount of the persistent contaminants that is about the same as or less than an amount of the persistent contaminants contained in the sewage;
mixing the ozofractionated trade wastewater into the sewage to produce a combined wastewater;
ozofractionating the combined wastewater under conditions whereby a foam fractionate comprising persistent contaminants in the combined wastewater is produced and separated from an ozofractionated combined wastewater;
quiescing the ozofractionated combined wastewater, whereby a residual ozone content of the ozofractionated combined wastewater is reduced; and
contacting the quiesced ozofractionated combined wastewater with a microorganism population under conditions effective to biologically remediate the ozofractionated wastewater.

Advantageously, the method of the second aspect of the present invention enables wastewater from multiple sources to be subject to different remediation programs, but ultimately undergo final treatment at the same wastewater treatment plant (e.g. a municipal waste water treatment plant or a site specific waste water treatment plant). Such methods would provide significant cost savings in the remediation of sewage wastewaters and trade wastes containing persistent contaminants. As will be described in further detail below, the combination of ozofractionations of varying intensities and enhanced biological remediation (due to the ozofractionation providing highly-favourable compounds for microorganism growth) has the potential to provide highly effective and efficient methods for treating multiple wastewater streams.

In some embodiments, ozofractionating the trade wastewater that contains persistent contaminants may comprise multiple ozofractionations, each subsequent ozofractionation further reducing the amount of the persistent contaminants contained in each subsequent ozofractionated wastewater. In some embodiments, the ozofractionation(s) may be carried out until the amount of the persistent contaminants contained in the ozofractionated trade wastewater is about half of the amount of the persistent contaminants contained in the receiving sewage. Such embodiments would ensure that there is little chance of the ozofractionated trade wastewater being added to the sewage exceeding any regulatory guidelines or requirements, or causing any potentially adverse environmental events.

Typically, the foam fraction (or combined foam fractions) containing the persistent contaminants from such ozofractionations are combined (if necessary), optionally concentrated and processed to destroy the persistent contaminants.

The ozofractionation or ozofractionations carried out on the trade wastewater will need to be relatively very aggressive, bearing in mind that the wastewater being treated may be heavily contaminated. In some embodiments, for example, ozofractionating the trade wastewater may comprise exposing the wastewater to an amount of ozone effective to increase the oxidation reduction potential (ORP) of the wastewater to above about 750 mV, or even as high as 1,400 mV if the wastewater contains heavy metals. In some embodiments, for example, ozofractionating the wastewater may comprise exposing the wastewater to a foam of bubbles comprising ozone having a size of less than about 200 μm. In some embodiments, for example, ozofractionating the wastewater may comprise exposing the wastewater to an amount of ozone of between 50-150 mg/L/hour.

In some embodiments, the ozofractionated combined wastewaters may be treated in accordance with the method of the first aspect of the present invention.

Other aspects, features and advantages of the present invention will be described below.

### BRIEF DESCRIPTION OF DRAWINGS

Embodiments of the present invention will be described in further detail below with reference to the following drawings, in which:

FIG. 1 is a block flow diagram of an embodiment of the first aspect of the present invention;

FIG. 2 is a block flow diagram showing a membrane bioreactor (MBR) which is another form of biological digester which could be used instead of the activated sludge process shown in FIG. 1;

FIG. 3 is a block flow diagram of an embodiment of the second aspect of the present invention; and

FIG. 4 is a simplified block flow diagram of an embodiment of the second aspect of the present invention.

### DETAILED DESCRIPTION OF THE INVENTION

The overarching purpose of the present invention is to remediate a wastewater comprising sewage and persistent contaminants. The wastewater may be a domestic wastewater such as sewage, which has been found to contain a disturbingly high amount of such contaminants. The wastewater may also be sewage into which trade wastewater including persistent contaminants has been mixed. In specific embodiments, the present invention may advantageously be used to remediate persistent contaminant-containing wastewaters at centralised sewage treatment plants, utilising existing infrastructure.

The present invention thus provides a method for remediating se age that contains persistent contaminants. The method comprises ozofractionating the sewage under conditions whereby a foam fractionate comprising persistent contaminants is produced and separated from an ozofractionated wastewater, quiescing the ozofractionated wastewater, whereby a residual ozone content of the ozofractionated wastewater is reduced, and contacting the quiesced ozofractionated wastewater with a microorganism population under conditions effective to biologically remediate the ozofractionated wastewater.

The present invention also provides a method for co-remediating sewage that contains persistent contaminants and a trade wastewater that contains persistent contaminants. The method comprises:
ozofractionating the trade wastewater under conditions whereby a foam fractionate comprising persistent contaminants is produced and separated from an ozofractionated trade wastewater which contains an amount of the persistent contaminants that is about the same as or less than an amount of the persistent contaminants contained in the sewage;
mixing the ozofractionated trade wastewater into the sewage to produce a combined wastewater;
ozofractionating the combined wastewater under conditions whereby a foam fractionate comprising persistent contaminants in the combined wastewater is produced and separated from an ozofractionated combined wastewater;
quiescing the ozofractionated combined wastewater, whereby a residual ozone content of the ozofractionated combined wastewater is produced; and
contacting the quiesced ozofractionated combined wastewater with a microorganism population under conditions effective to biologically remediate the ozofractionated wastewater.

### Sources of Wastewater

The methods of the present invention may be used to remediate wastewaters comprising sewage, persistent contaminants and, optionally trade wastewater. In some aspects, the invention relates to remediating sewage impacted with persistent contaminants and, in other aspects, co-remediating sewage and trade wastewater which both contain persistent contaminants. The quantity of the contaminants in the mediated wastewater or combined wastewaters would usually be governed by applicable regulations.

As will be appreciated by a person skilled in the art, “Sewage” (also known as domestic/municipal wastewater) is a wastewater that is produced in domestic situations and which includes mainly greywater (e.g. from sinks, bathtubs, showers, washing machines, etc.) and some blackwater (e.g. the water used to flush toilets and the human waste contained therein).

As used herein, the term “Trade wastewater” is to be understood to mean a wastewater that originates from a non-domestic (e.g. industrial) environment. Non-limiting examples of trade wastewaters include wastewaters from industrial processes, as well as contaminated groundwater and contaminated surface water.

Many chemical species will not degrade under typical environmental conditions because they are resistant to environmental degradation though chemical, biological and photolytic processes. To take but one example, the chemical species collectively referred to as polyfluoroalkyl substances (PFAS), which includes perfluorooctane sulfonate (PFOS), perfluoro-octanoic acid (PFOA) and perfluorohexane sulfonate (PFHxS) were, for many years, used to coat fabrics, carpets and other textiles for stain resistance, to create ‘non-stick’ cookware, in paper manufacturing, metal finishing processes and, infamously, to make an aqueous film-forming foam as a fire suppressant and used at airfields, petroleum refineries, oil rigs and fire departments worldwide. These compounds are, however, persistent toxins, with some being carcinogens that appear to persist indefinitely in the environment. Many sites within Australia, and around the world, are now heavily contaminated with PFAS and, in some locations, this contamination has entered water supplies. Persistent contaminants which are contained in wastewaters able to be remediated in accordance with the present invention include PFAS and many other organic compounds, pesticides, insecticides, biocides pharmaceuticals and emerging contaminants such as micro plastics. The invention will be described below mainly in the context of treating PFAS, but the general applicability of the methods of the present invention for treating other persistent contaminants will be immediately apparent for other domestic and trade wastewater contaminant species.

As noted above, enhanced water testing techniques have relatively recently indicated that significant quantities of persistent contaminants such as PFAS and many other organic compounds, biocides, pesticides, pharmaceuticals and microplastics are present in sewage in relatively low, but still detectable and problematic, amounts. These contaminants can find their way into the sewage system in the form of illegal trade wastewater disposal, leachates from landfills or other areas where sources of the contaminants are stored, or via direct action such as where accidental spills occur.

Given the volume of sewage that would usually require treatment, many existing domestic wastewater treatment techniques are simply not able to effectively remediate the sewage and remove these contaminants. Indeed, existing sewage treatments are being found to be inadequate, due to sonic of the persistent contaminants being found to bio-accumulate in the sludge by-product from conventional treatment plants. As such sludge is commonly used to fertilize the ground used to grow foodstuffs for animal and human consumption, this is of great concern. Furthermore, sewage that has been remediated using conventional sewage treatment plants (and hence will still likely contain PFAS) is often used to irrigate food crops, where it can be recycled back into the food chain and consumed by the general population.

As described above, the inventor has discovered that, contrary to conventional wisdom, ozofractionation aggressive enough to separate persistent contaminants from sewage (or sewage-containing wastewater) can be used in combination with the conventional biological digestions carried out at wastewater treatment plants to remediate the sewage. By removing the persistent contaminants (or at least the vast majority of the persistent contaminants) before exposing the sewage to the biological cultures, the likelihood of the contaminants becoming entrained in the activated sludges or carried over into effluents is greatly reduced. Even should some persistent contaminants survive ozofractionation, the recycling steps described below in the context of preferred embodiments of the present invention should ensure that any used sludge collected from the treatment plant is not contaminated.

The inventor has also discovered that it may be possible to co-remediate sewage with other forms of wastewater that are more heavily contaminated with persistent contaminants, but which have been pre-treated to reduce the level of contamination. Significant process and cost efficiencies may be achieved by combining the treatment processes for sewage (which has a high volume and a relatively low level of contamination) and other wastewaters (which may have variable volumes and levels of contamination). Indeed, given the expense associated with techniques required to polish or completely decontaminate (i.e. to below detection levels) a heavily-contaminated trade wastewater, the inventor realised that it may be beneficial to direct the effluent from a treatment process of such a heavily contaminated wastewater that has a residual content of the contaminant which is about the same as (e.g. about 90%, up to about 100% of), or slightly less than (e.g. 75%, 50%, or 25% of), that in the sewage, into the sewage for co-remediation therewith. The sewage needs to be remediated regardless, and adding the effluent from the treatment process into the sewage does not significantly affect the amount of persistent contaminants in the combined wastewaters. In this manner, the final removal of the persistent contaminants in both wastewater streams occurs in the same treatment plant, where efficiencies of scale are available.

In a second aspect therefore, the method may involve the co-treatment of two streams of wastewater, one of which is sewage containing relatively low levels of persistent contaminants (e.g. PFAS, microplastics, etc.). The other wastewater may, for example, be a moderate to highly impacted trade wastewater, such as an industrial wastewater or a contaminated groundwater or surface water. Such wastewaters are to be found at many sites around the world, and especially the groundwater adjacent airports, where fire-fighting foams containing PFAS chemicals were used extensively for decades before its acute toxicity became fully understood. It will be appreciated, however, that trade wastewater from many other sources may contain moderate to high amounts of persistent contaminants, and be capable of remediation in accordance with the present invention.

Advantages of co-remediating two streams of wastewater in accordance with this aspect of the present invention are noted above. Additional benefits include a reduction in the potential for cross-contamination of water types, a reduction in the generation of contaminant-impacted waste material (e.g. PFAS-impacted waste material), maximising the treatment efficiency and discharge compliance. as well as an improvement in the ability and flexibility to treat ‘shock loads’ to either system.

As would be appreciated, although described herein in the context of co-remediating two wastewater streams, the present invention has the potential to also be used for co-remediate three, four, five or more wastewater streams.

The methods of the present invention may be performed at any suitable water treatment plant. In some embodiments, for example, the water treatment plant may be a purpose-built plant, for remediating wastewater specific to a certain location. In alternative embodiments, the water treatment plant may be a centralised sewage treatment plant, possibly including retro-fitted apparatus (primarily ozofractionation chambers, etc., as described below) in order for it to be capable of performing the methods of the present invention. In some embodiments, the methods may be performed at a municipal sewage treatment plant.

### Ozofractionation

The ozofractionation process, as used to decontaminate industrial fluid wastes, is described in detail in the inventor's earlier international patent application, published as WO 2013/016775, the contents of which are hereby incorporated in their entirety. In brief, and as noted above, ozofractionation is a technique during which a wastewater is exposed to a flow of tiny bubbles of a gas feed including ozone (in effect, a foam of ozone-containing bubbles) that rise upwardly through the wastewater towards the top of an ozofractionation chamber. Some ozone diffuses out of the bubbles, where it decomposes to form species including oxygen and hydroxyl radicals. Both of these decomposition products are strong oxidants which can oxidise species with the chamber. Other species (e.g. particulate material or longer chain molecules) may adsorb to the (highly charged) surface of the ozone bubbles and form part of a foam fractionate which collects at the top of the ozofractionation chamber, where it may be separated from the remainder of the liquid in the chamber.

The ozone within the gas bubbles also provides a strong zeta potential on the surface of the micro bubbles, discouraging coalescence and maintaining a finely bubbled foam within the chamber. The massive surface area provided by the micro bubbles creates a strong affinity and surface area for hydrophobic compounds to migrate to. Relevantly, ozofractionation aggressively partitions long-chain molecules such as PFAS to fraction and converts oxidisable PFAS precursor compounds to PFAS species compatible with removal by fractionation.

Ozofractionation is an enhanced foam fractionation process that, in addition, aggressively decomposes urea ((NH₂)₂CO+O₃->N₂+CO₂+2 H₂O) and ammonia. Ozofractionation also converts COD to BOD and increases available TOC by direct oxidation of complex long chain inorganic hydrocarbon compounds. These two effects allow a substantially increased nitrogen and phosphorus reduction efficiency of >90% from treated sewage.

Ozofractionation also facilitates the removal (by flotation, micro-flocculation and direct oxidation) of non-filterable residues (NFR), dissolved organic molecules (DOM), as well as the coagulation of colloidal sized particles and other suspended solids. Significantly, ozofractionation usually increases the Oxidation/Reduction Potential (ORP) of the wastewater, which increases the efficiency of the wastewater to be oxidised and digested in the following biological aeration stage.

Oxidation reduction potential (ORP) is a measurement which is a key indicator of ozone utilisation in the ozofractionation process, and is indicative of the oxidation activity on species (including the contaminants) in the wastewater being treated. During ozofractionation, the ORP of the wastewater can be measured, and the amount of ozone added to the ozofractionation chamber may be increased or decreased in order to maintain a set point which is governed by the chemistry required to achieve the desired remediation. Appropriate set points for each stage in the methods of the present invention will depend on the wastewater being treated and would usually be empirically determined during the commissioning phase. The presence of ozone scavengers such as sodium thiosulphate in a wastewater can affect the ORP measurements, but their presence would typically be noted during the commissioning phase and their effect taken into account.

Aggressive ozofractionation involves performing the ozofractionation at an efficiency and under conditions where the ORP rises by an amount that results in the wastewater containing a high proportion of oxidising species and ozone bubbles having a high zeta potential, which generally makes them even more strongly attract persistent contaminants. Although dependent on factors such as the type of water being ozofractionated (e.g. the ORP of fresh water is usually between about 80-250 mV and that of sea water between about 350-420 mV) and the contaminants contained therein (e.g. metals dissolved in a water would generally increase its ORP), ORPs of above about 600 mV are generally considered by the inventor to be aggressive. Higher ORPs may also be required for some wastewaters, especially where they may already have a relatively high ORP due to contaminants, or where they contain highly recalcitrant contaminants. In some embodiments, for example, aggressive ozofractionation may be characterised by ORPs of about 700 mV, 750 mV, 800 mV, 850 mV, 900 mV, 950 mV, 1,000 mV, 1.050 mV, 1,100 mV, 1,150 mV, 1,200 mV, 1,250 mV, 1,300 mV, 1,350 mV, 1,400 mV or 1,450 mV. In some embodiments, for example, aggressive ozofractionation may be characterised by a change in ORP of between about 250 and 350 mV, between about 350 and 450 mV, between about 450 and 550 mV, between about 550 and 650 mV, between about 650 and 750 mV, between about 750 and 550 mV or between about 850 and 950 mV.

Ozofractionation can also be performed under milder conditions than those described above, and which can cause relatively complex organic species present in sewage to be oxidised and form species that are more easily and effectively digestible by microbes. In effect, such mild ozofractionation can maintain the ORP of the ozofractionated water at a level that is compatible with an enhanced microbial activity. Again, although depending on factors such as the water being ozofractionated and the contaminants contained therein, ORP increases of below about 200 mV are generally considered to be mild.

The aggressiveness of ozofractionation can be moderated by factors such as the bubble size, the duration of ozofractionation (i.e. contact time in the ozofractionation chamber), the amount of the ozone-containing gas delivered into the chamber, as well as the proportion of ozone and other components of the ozone-containing gas in the bubbles.

The duration of ozofractionation will depend on the nature of the wastewater(s) and can be determined empirically. For heavily contaminated wastes, ozofractionation times may be from about 1 hour to about 4 hours (e.g. from about 1 hour to about 3 hours or from about 1 hour to about 2 hours or about 1.5 hours). For lightly contaminated wastes, ozofractionation times may be as little as 30 seconds, but will more commonly be from about 5 minutes to about 45 minutes (e.g. from about 15 minutes to about 35 minutes or from about 20 minutes to about 30 minutes or about 25 minutes). In some embodiments, the wastewater may be ozofractionated for about one hour.

The ratio of ozone to other gas/gasses in the bubbles will also affect the ozofractionation's efficiency. The ozone may, for example, be mixed with oxygen where an aggressive ozofractionation is required, or mixed with dried air where a milder ozofractionation is required. The ratio of ozone/oxygen may be as high as about 13% (v/v) in very aggressive ozofractionations, but will vary (downwards) dependent on factors such as bubble size and target ORP. Above 13% the bubbles tend to combine, which reduces the effectiveness of the process. In some embodiments, for example, the ratio of ozone/oxygen (or ozone/dried air) may be about 13% (v/v), 12% (v/v), 11% (v/v), 10% (v/v), 9% (v/v), 8% (v/v), 7% (v/v), 6% (v/v), 5% (v/v), 4% (v/v), 3% (v/v), 2% (v/v) or even 1% (v/v).

The ozone may, for example, be mixed with dried air where a less aggressive ozofractionation is required. The ratio of ozone/air (or ozone/oxygen) in such embodiments may be about 3% (v/v), 2% (v/v), 1% (v/v), 0.5% (v/v), 0.25% (v/v), 0.1% (v/v), 0.05% (v/v) or 0.025% (w/v).

Ozone leftover or recycled from other ozofractionation stages in the method (described below) may be used as a source of ozone in such relatively mild ozofractionations.

The size of the bubbles of ozone can also affect the relative efficiency of the ozofractionation. In general, the smaller the bubble, the larger its surface area and the better able it is to facilitate mass transfer of ozone out of the bubble. Smaller bubbles also tend to have a higher charge density. In some embodiments, for example, ozofractionating the wastewater may comprise exposing the wastewater to a foam of bubbles comprising ozone, where the bubbles have a size of less than about 250 μm or 200 μm (e.g. less than about 150 μm, less than about 120 μm, less than about 100 μm, less than about 80 μm or less than about 50 μm). Bubbles size can be measured using high speed video.

In some embodiments, the foam comprising ozone may be exposed to UV light. If so, the UV exposure is typically performed after the foam has been produced in the venturi, but before the loam contacts the wastewater. In some embodiments, the ozofractionation process may be modified to include other advanced oxidization processes, such as may be caused by adding Fenton's Reagent, for example.

### Treating Heavily Impacted Wastewater

In the second aspect of the present invention, sewage and a trade wastewater that both contain persistent contaminants are co-remediated. Before the wastewater that contains persistent contaminants (e.g. a moderate to highly impacted PFAS-containing wastewater) is mixed into the sewage to produce a combined wastewater, it is ozofractionated under conditions whereby a vast majority of the persistent contaminants are removed with a foam fractionate produced during ozofractionation. In this manner, the wastewater obtained from a contaminant “Hot spot” can be remediated in a relatively straightforward manner in order to significantly reduce (but not completely eliminate) the amount of contaminant. Indeed, the most expensive and complicated step when remediating wastewater from a contaminant “Hot spot” such that the contaminant is below detectable levels is usually the final polish.

The goal of this ozofractionation (or these ozofractionations, where multiple ozofractionations are performed on the trade wastewater before it is mixed into the sewage) is to produce an ozofractionated trade wastewater that contains an amount of persistent contaminants which is about the same as, or less than, that contained in the sewage. In this manner, adding the ozofractionated trade wastewater into the sewage does not cause a spike of contaminants in the combined wastewater and nor are additional (often relatively difficult and expensive) treatments required to fully remediate the trade wastewater. Furthermore, obtaining approval from regulatory authorities to introduce a wastewater into a sewer which contains a higher amount of contaminants (of any form) may be difficult to obtain.

The amount of persistent contaminants that may remain in the ozofractionated trade wastewater will vary, depending on factors including the amount and type of contaminants in the sewage and regulatory requirements. It would be within the ability of a person skilled in the art, using no more than routine measurements, trial and experiments, to establish appropriate parameters for any particular trade wastewater and sewage co-remediation. In some embodiments, for example, the amount of the persistent contaminants in the ozofractionated trade wastewater to be introduced into the sewage may be about 1.5×, 1.4×, 1.3×, 1.2×, 1.1×, 1.0×, 0.9×, 0.8×, 0.7×, 0.6×, 0.5×, 0.4×, 0.3×, 0.2× or 0.1× the amount of the persistent contaminants in the sewage.

The quantity of persistent contaminants in sewage will vary depending on factors such as the source of the sewage and the nature of the persistent contaminant(s). Australian sewage, for example, has been found to contain between about 0.1 to 3 μg/L PFAS, which is significantly higher than the standard guidelines for drinking water of 0.07 μg/L PFAS. Remediation of this sewage (i.e. where the amount of the persistent contaminants is at least below regulatory guidelines) is therefore obviously a desirable goal, and one which the present invention is expected to be able to achieve.

Given the inventor's surprising and unexpected discovery that ozofractionation can be used to remove persistent contaminants before an impacted sewage undergoes biological remediation, the inventor reasoned that it should be possible to combine pre-treated wastewater from a contaminant “Hot spot” (which, due to its pre-treatment, may even contain less of the contaminant than that in the sewage) and co-remediate the combined wastewaters. Such a method would not necessarily require the final polish referred to above and may result in significant (orders of magnitude) cost savings, and with similarly compliant effluents.

The ozofractionation car ozofractionations carried out on the trade wastewater that contains persistent contaminants will need to be relatively very aggressive, bearing in mind that the wastewater being treated may be heavily contaminated. It is within the ability of a person skilled in that art to determine how aggressive the ozofractionation of a particular trade wastewater needs to be, depending on factors such as the nature and source of the wastewater being treated, the amount of persistent contaminant(s) contained therein, the type and amount of co-contaminants (e.g. other, non-persistent contaminants, such as dissolved solids), as well as the physical characteristics of the wastewater (e.g. its pH, ORP, etc.). Compliance with local regulations will also govern the nature of this ozofractionation, as this is where the majority of the persistent contaminant will likely be removed.

In some embodiments, ozofractionating trade wastewater from a “Hot spot” may comprise exposing the wastewater to an amount of ozone effective to increase the oxidation reduction potential (ORP) of the wastewater to above about 650 mV, 700 mV, 750 mV or 800 mV. It should, however be noted that in embodiments where extremely persistent contaminants are present in the wastewater, and especially where the wastewater includes co-contaminants such as some metals (which tend to increase the water's ORP), ORPs as high as 1,400 mV may be used.

In some embodiments, ozofractionating the trade wastewater may comprise exposing the wastewater to a foam of bubbles comprising ozone having a size of less than about 200 μm (e.g. less than about 150 μm or less than about 120 μm, less than about 100 μm, less than about 80 μm or less than about 50 μm).

In some embodiments, ozofractionating the trade wastewater may comprise exposing the wastewater to an amount of ozone of between 50-150 mg/L/hour (e.g. between 50-100 mg/L/hour, between 100-150 mg/L/hour or between 80-120 mg/L/hour). Given the need for an aggressive ozofractionation, an ozone/oxygen gas mixture would probably be utilised, with the proportion of ozone being at the higher end of the range described above.

Retention times of between about 45 min and 90 min (e.g. about an hour) would usually be sufficient, again depending on co-contaminates, with subsequent ozofractionations (if any) typically having relatively shorter retention times.

In some embodiments, ozofractionating the trade wastewater may comprise multiple ozofractionations, with each subsequent ozofractionation further reducing the amount of the persistent contaminants contained in each subsequent ozofractionated wastewater. In such embodiments, the ozofractionations may be carried out until the amount of the persistent contaminants contained in the ozofractionated wastewater is about the same as (or less than, e.g., 25-50% of the amount of the persistent contaminants in the sewage) an amount of persistent contaminants contained in the sewage. Mixing the ozofractionated wastewater from the final ozofractionation into the sewage would therefore not risk “spiking” the combined wastewater with the contaminant.

Typically, the foam fraction (or combined foam fractions) containing the persistent contaminants from the ozofractionations are optionally concentrated and processed to destroy the persistent contaminants. Suitable destruction techniques will be described below.

### Primary Ozofractionation

Both aspects of the present invention ozofractionate the wastewater before it undergoes any biological remediation. The wastewater (or combined wastewater, in the second aspect of the present invention) is ozofractionated under conditions whereby a foam fractionate comprising persistent contaminants (i.e. which are not otherwise destroyed by the ozone) is produced and separated from an ozofractionated wastewater (a combined wastewater in the second aspect). In this step, the vast majority of any persistent contaminants in the wastewater can be partitioned in the foam fractionate and thus separated before the wastewater reaches the microorganism population (e.g. downstream in a sewage treatment plant). As described above, if such a separation did not occur, the persistent contaminants would pass through the treatment unchanged and/or be taken up by the microorganisms during treatment.

The primary ozofractionation carried out pre-biological digestion needs to be relatively aggressive in order to oxidise contaminants (e.g. some persistent organic toxins and pharmaceuticals contaminations), cause other contaminants to adsorb onto the rising ozone-containing bubbles, and converting long-chain complex hydrocarbons present in the sewage/wastewater into short-chain and more biologically available forms. As noted above, ozofractionation may also assist in reducing total nitrogen and phosphorous and resolve colour issues often present with humic substances in sewage streams, due to the increased ORP of the ozofractionated wastewater enhancing the efficiency of the biological cultures. This being said, the primary ozofractionation must not be so aggressive that the microorganism population might be adversely affected due to exposure to ozone or extremely energised ozofractionated wastewater.

Ozofractionating the wastewater/combined wastewaters may comprise exposing the wastewater to an amount of ozone effective to increase the oxidation reduction potential (ORP) of the wastewater to above about 650 mV, 700 mV, 750 mV, 800 mV, 850 mV, 900 mV, 950 mV or 1000 mV.

Ozofractionating the wastewater/combined wastewaters may comprise exposing the wastewater to a foam of bubbles comprising ozone having a size of less than about 200 μm (e.g. less than about 150 μm or less than about 120 μm). Typically, an ozone/oxygen gas mixture would be used in the primary ozofractionation, although an ozone/air gas mixture may suffice for some wastewaters.

Ozofractionating the wastewater/combined wastewaters may comprise exposing the wastewater to an amount of ozone of between 5-150 mg/L/hour. In some embodiments, for example where the persistent contaminant is a molecule having a long chain which tends to readily adsorb to the rising ozone bubbles and is hence more easily removed from the wastewater, the wastewater may be exposed to an amount of ozone of between about 5-15 mg/L/hour. In such embodiments, there may be less need to aggressively oxidise the wastewater to destroy species contained therein.

Alternatively, in other embodiments, the wastewater/combined wastewaters may need to be exposed to an amount of ozone of between about 50-150 mg/L/hour (e.g. between 50-100 mg/L/hour, between 100-150 mg/L/hour or between 80-120 mg/L/hour) in order to increase the ORP by the required amount and either separate or destroy the persistent contaminants).

Relatively larger amounts of ozone may be required, for example, if treating trade wastewaters from sources such as from an abattoir, for example. Such wastewater would typically have a very high organic loading (e.g. BOD of up to 2,000), compared to that of domestic sewage (which typically has a BOD of 150-310). The relatively higher organic loading necessitates greater amounts of ozone in order to maintain the ORP at the determined set point in the ozofractionation chamber.

### Quiescence

Once the wastewater or combined wastewaters has undergone the primary ozofractionation described in the preceding paragraphs, it is quiesced such that a residual ozone content of the ozofractionated wastewater is reduced. This step is important because wastewater containing too much ozone would likely kill microorganisms with which it was contacted and hence reduce the microorganism population, possibly to a level where it becomes incapable of biologically remediating the wastewater.

Determining whether the ozofractionated wastewater has quiesced by a sufficient amount may be achieved by monitoring the wastewater to determine its ORP. Alternatively, the effectiveness of the downstream microorganism population may be closely monitored, with the quiescence time of the ozofractionated wastewater being increased/decreased as necessary.

Any suitable technique may be used to quiesce the ozofractionated wastewater. Given that ozone degrades in water in the manner described above relatively quickly, all that may be required in order to quiesce the ozofractionated wastewater is to allow it to stand for a period of time to enable substantially all of the residual ozone in the ozofractionated wastewater to be utilised (i.e. via the reactions described above).

In some embodiments, for example, quiescence may occur during transfer of the ozofractionated wastewater to the microorganism population (e.g. during turbulent mixing within a length of pipe). Alternatively (or in addition), quiescence may occur whilst the ozofractionated wastewater resides temporarily in a surge tank (or other storage vessel), which may also help to regulate the flow of wastewater through the biological stage(s) of the remediation.

### Primary Digestion

In both aspects of the present invention, the quiesced ozofractionated wastewater or combined wastewater is contacted with a microorganism population under conditions effective to biologically remediate the ozofractionated wastewater. The biological remediation used in the methods of the present invention may be any suitable digestion process and may utilise any suitable biological cultures (e.g. bacteria, protozoa, algae, macrophyte algae, etc.). The present invention may include one or more bacterial digestion stages, where such would beneficially remediate any given sewage-containing wastewaters.

The ozofractionated wastewater may, for example, be contacted with a first microorganism population in a primary biological digester configured for anoxic, anaerobic or aerobic treatment. Such a primary digestion can be used to separate solids (which settle to the bottom of the digester) from the supernatant wastewater, which undergoes further treatment.

The simplest and most common form of a primary wastewater treatment is an anaerobic digestion (commonly referred to as a septic tank), which has been used for domestic purposes for approximately 125 years with little change in design. Thus, in some embodiments, the primary biological digestion is anaerobic. Alternatively, a combination of anaerobic and aerobic digestions may occur in the same chamber during the primary digestion. Chambers capable of providing such functionality are known in the art.

Typically, the activated sludge which settles during the primary biological digestion is recycled hack into the wastewater pre-ozofractionation. Such recycling ensures that any persistent contaminants which may have passed through the primary ozofractionation and become incorporated into the sludge (e.g. as is known to occur for PFAS) are re-treated where any such contaminants are likely to be liberated and separated in the foam.

As ozofractionation is carried out on the feed into the microorganism population (e.g. into a sewage treatment plant), a source of biological cultures that would continually replenish the microorganism population in a conventional sewage treatment plant is no longer available (the biological cultures would be unlikely to survive ozofractionation). The method of the present invention may therefore further comprise maintaining the microorganism population such that it remains effective to biologically remediate the ozofractionated wastewater. The microorganism population may be maintained using any suitable technique, perhaps most simply by adding additional microorganisms (e.g. into the biological digester) in order to maintain an effective microorganism population.

Interestingly, the inventor has also observed beneficial effects on sludge age during trials of the present invention. Sludge age is the amount of time, in days, that solids or bacteria are under aeration, and is used to maintain the proper amount of activated sludge in the aeration tanks. It is generally desirable to reduce sludge age in order for biological digestion processes to occur more rapidly, which can reduce hydraulic retention time in the plant and hence decrease the required plant size. The inventor has discovered that the primary ozofractionation described herein effectively reduces the sludge age, further enhancing the subsequent biological digestion. Without wishing to be bound by theory, the inventor believes that ozofractionation reduces the ammonia content of the wastewater by converting it into nitrates and nitrites, which are more easily digestible.

### Secondary Ozofractionation

In some embodiments of the present invention, the methods may further comprise treating the wastewater or combined wastewaters after the primary biological digestion in order to increase the ORP of the wastewater before further biological remediation. Such treatment may help with the removal of additional contaminants, as well as managing the ORP for optimal culture conditions for subsequent biological remediation, thus enabling the highest efficiency of the bacterial cultures in order to help to biodegrade species in the wastewater faster or more completely. For instance, in the process of switching between anaerobic to aerobic biological remediations, the ORP may be elevated from an anaerobic −200 mV to an aerobic +150 mV in order to optimise the aerobic stage microorganisms' efficiency.

Any technique capable of increasing the ORP of the wastewater may be used in such embodiments. For example, the method may further comprise a secondary ozofractionation of the wastewater (or combined wastewaters) after the primary biological digestion. Such a secondary ozofractionation would be performed under conditions effective to manage (e.g. by increasing) the ORP of the wastewater and convert species in the wastewater into smaller species that are more conducive to subsequent aerobic biodegradation. Alternatively, or in addition, the ozofractionation may be effective to reduce overall suspended solids within the wastewater and thus the overall nutrient loading of the wastewater.

Such an ozofractionation cannot be too aggressive, lest this deleteriously affect the microorganism population required for effective further biological remediation. The secondary ozofractionation may, for example, comprise exposing the wastewater to an amount of ozone effective to increase the oxidation reduction potential (ORP) of the wastewater to between about 50 to 200 mV (e.g. 150 to 200 mV). The secondary ozofractionation may, for example, comprise exposing the wastewater to an amount of ozone (usually in a dried air/ozone gas mixture, containing as little as 0.25% to 1% v/v ozone) of about 0.5 mg/L/hour to about 5 mg/L/hour. The ozone used in this ozofractionation may be recycled from elsewhere in the process.

In some embodiments, foam fractionate produced during the secondary ozofractionation may be combined with the foam fractionate from the primary ozofractionation. The combined fractions may then be transferred together for subsequent processing (e.g. destruction), as described below.

### Aerobic Digestion

In some embodiments of the methods of the present invention, the ozofractionated wastewater (or combined wastewaters) may be biologically remediated (or further biologically remediated, if the primary digestion step described above has been performed) in an activated sludge process, a membrane bioreactor process, a membrane aerated bioreactor process, a trickling filter, or in any appropriate biological digestion with an ORP set point that can be optimised for best effectiveness. Examples of such processes are described below in the context of specific embodiments of the present invention, and alternatives will be well known to those of ordinary skill in the art.

Similar to the primary digestion stage described above, and noting that natural seeding of the microorganism population will not occur as is the case for conventional sewage treatments, the method of the present invention would typically further comprise maintaining the microorganism population whereby it remains effective to biologically remediate the ozofractionated wastewater. The microorganism population may be maintained using any suitable technique, perhaps most simply by adding additional microorganisms (i.e. by “Seeding” the digester) in order to maintain a microorganism population effective for the required biological digestion.

Also similar to the primary digestion stage described above, the activated sludge produced during the biological remediation would typically be recycled back into the wastewater pre-ozofractionation.

In some embodiments, a third biological digestion stage may be desirable or advantageous, depending on factors such as the sewage/trade wastewater being treated and its biological loading, as well as environmental discharge compliance requirements.

### Tertiary Ozofractionation

In some embodiments of the present invention, the methods may further comprise a further ozofractionation (i.e. a tertiary ozofractionation, where the secondary ozofractionation described above has already taken place), in which the biologically remediated wastewater is re-ozofractionated under conditions whereby particulate material is captured in a foam fractionate for separation. A portion of the re-ozofractionated wastewater may also be recycled back into the microorganism population.

Such a tertiary ozofractionation should only be very mild, especially if the re-ozofractionated wastewater is recycled back into the microorganism population in the digestion chamber. The tertiary ozofractionation may, for example, comprise exposing the wastewater to an amount of ozone (in a dried air/ozone gas mixture containing less than 1% v/v ozone) of between about 0.00005 and about 0.005 mg/L/hour.

The rate of ozofractionation would usually be quite high (i.e. the retention time in the tertiary ozofractionation chamber would be relatively short), with it usually being desirable for a majority of the re-ozofractionated wastewater to be recycled back into the microorganism population in order to maintain the most efficient ORP for biological digestion. Recycling between 2× to 6× of the volume of the digestion chamber per hour through the ozofractionator has been found by the inventor to be effective.

### Other Processes

In some embodiments, the methods of the present invention may include additional steps, where such steps will result in a beneficial outcome and not detrimentally affect the purpose of the invention.

In some embodiments, for example, the methods may further comprise subjecting the biologically remediated ozofractionated wastewater to a final treatment process in order to comply with more stringent environmental discharge requirements. Such a further remediation process may, for example, comprise disinfecting the biologically remediated ozofractionated wastewater (e.g. with chlorine, if the wastewater is to be allowed to stand for periods of time post-remediation). Alternatively (or in addition), ion exchange may be used to absorb any leftover nitrogen-containing species, which might be environmentally damaging if discharged to the environment.

### Destruction of Fractions

In some embodiments, the methods of the present invention may involve the destruction of the persistent contaminants contained in the foam fractionate(s). Any suitable destruction technique may be used to achieve this, bearing in mind the nature of the specific persistent contaminants. Some examples of techniques of which the inventor is aware include the so-called PFAS Harvester currently in development, as well as more conventional techniques such as sonolysis, heating (either directly or via a plasma arc generator) or by exposure to an extreme oxidation (e.g. as is described in detail in the inventor's earlier international patent application, published as WO 2018/107249, the contents of which are hereby incorporated in their entirety). The method chosen will depend on the scale of fraction production at either the “Hot spot” (relatively small volumes and perhaps suited to sonolysis) or the centralised sewage treatment plant (large volumes, more suited to the production of hydrogen rich SynGas in a PFAS Harvester).

In some embodiments, the foam fractionates may be concentrated (e.g. under vacuum) before the persistent contaminants are destroyed in order to even further reduce the volume of material for destruction (which may be expensive).

Specific embodiments of the present invention will now be described in the context of remediating PFAS contaminated sewage and wastewaters. As the proposed implementation site has not been identified, the influent variables and discharge requirements are therefore also not yet defined. The description set out below is therefore based on a theoretical site that allows for a description of the treatment methods.

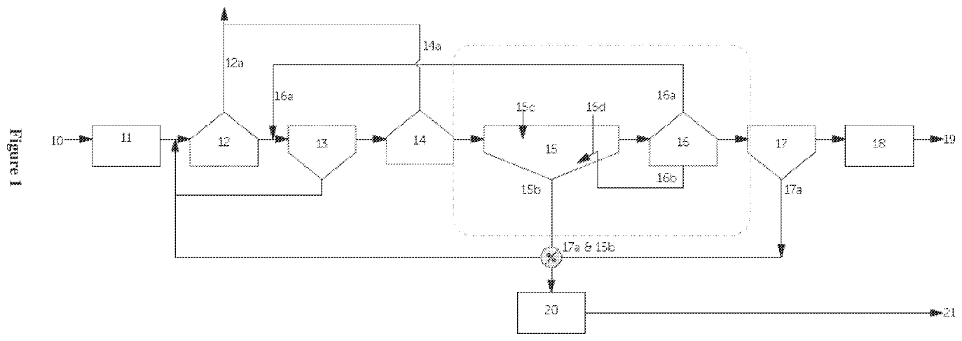

Referring firstly to FIG. 1, shown is a block flow diagram of an embodiment of the first aspect of the present invention, in which an influent 10 from a PFAS impacted sewage is introduced into the process for remediation. The influent may come directly from the sewer and may be either domestic sewage or an industrial sewage (e.g. from an abattoir). The incoming sewage is screened at 11, primarily to remove sanitary and other solid items, which are directed to a grits bin and disposed of after undergoing a washing process to liberate PFAS compounds (wash not shown in block flow diagram).

The incoming sewage then undergoes a primary ozofractionation 12, which produces a foam fraction 12a that contains approximately 3% (v/v) of the sewage but >99.97% of PFOS, PFOA, PFHxS and other long chain species that are attracted to the ozone bubbles. The concentration of such persistent contaminants may be between about 100 up to greater than 1000× concentrated from influent concentration because ozofractionation aggressively partitions PFAS to fraction and converts oxidisable PFAS precursor compounds to PFAS species compatible with removal by fractionation. Oxidisable species that are oxidised are either removed to fraction 12a or remain in the ozofractionated sewage. Fraction 12a may be removed from the process for subsequent processing (e.g. destruction, not shown).

The ozofractionated sewage then passes through a pipe and into primary treatment chamber 13. Whilst in the pipe, the sewage quiesces, whereupon any residual ozone in the wastewater is utilised in the manner described above. The ozofractionated sewage that enters chamber 13 is therefore substantially free of ozone. Introduction of fraction 16a from fractionation stage 16 into this pipe would also provide some turbulence, which may help to increase the rate at which any remaining ozone is utilised.

Once in the chamber 13, the ozofractionated sewage undergoes biological digestion in a conventional manner. The simplest and most common form of wastewater treatment is an anaerobic digestion (commonly known as a septic tank), which has been used for domestic purposes for approximately 125 years with little change in design. The septic tank process, or primary treatment, takes place in the primary chamber 13. Long flow path permits adequate flotation and settlement.

Activated sludge from chamber 13 is recycled back into the feed for ozofractionator 12, allowing any PFAS contained in the sludge to be liberated to fluid for capture in fraction 12a. This recycling prevents build-up of the persistent contaminant in the activated sludge, meaning that, once spent, it can safely be used for fertilisation etc. without the contamination issues described above.

Once the primary digestion 13 is complete, the wastewater is transferred to secondary ozofractionator 14, where a less aggressive ozofractionation tales place that produces a foam fraction 14a that contains approximately 3% (v/v) of the introduced wastewater. Fraction 14a may be combined with fraction 12a and removed for subsequent processing (e.g. destruction, not shown). Ozofractionation 14 has a relatively short retention time, enabling a relatively constant flow of sewage through the process to be maintained.

As noted above, ozofractionation combines foam fractionation with ozone. Ozofractionation is an enhanced fractionation process but, in addition, aggressively decomposes urea (via the reaction (NH₂)₂CO+O₃->N₂+CO₂+2H₂O). Ozofractionation also converts COD to BOD and increases available TOC by direct oxidation of complex long chain inorganic hydrocarbon compounds. These two effects allow a substantially increased nitrogen and phosphorus reduction efficiency of >90%. Constant transfer of fractionate from aerobic to anaerobic process (primary septic stage) facilitates activated sludge recycling, further increasing overall efficiency of the system.

Ozofractionation also facilitates the removal (by flotation, micro-flocculation and direct oxidation) of non-filterable residues (NFR), dissolved organic molecules (DOM), the coagulation of colloidal sized particles and other suspended solids. Significantly, ozofractionation can also increase the Oxidation/Reduction Potential (ORP) of the wastewater from about −300 mV to about +350 mV, which increases the efficiency of the fluid to be oxidised and digested in the following biological aeration stage.

The re-ozofractionated wastewater then moves into a biological aerator 15, where a secondary activated sludge process further biologically degrades the sewage. A type of activated sludge, in the biological aeration stage, the oxidised BOD, COD and TOC compounds from ozofractionation enter the stage at an ORP of around 300 mV. Bacterial & protozoan cultures metabolise the waste solids, producing new growth while taking in dissolved oxygen and releasing carbon dioxide. Some of the new microbial growth dies, releasing cell contents to solution for re-synthesis.

Sludge from the process may be recycled via 15b back into the primary ozofractionation 12 in order to remediate potentially contaminated sludge, or onto spent sludge processing 20, as described below. Compressed air 15c is injected into the aerator and/or air may be introduced under vacuum 15d.

The venturi set powering biological aerator 15 are driven from the base of the fractionation stage 16 (described below). Recirculating the fluids constantly between the two stages 15/16 facilitates the transfer of dead microbial growth, while simultaneously removing suspended solids and biological floc, which are returned as an activated sludge in fraction 16a to the anaerobic primary stage 13, as described above.

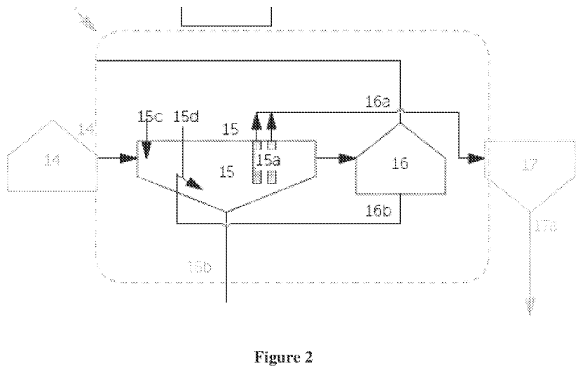

Biological reactor 15 may be any aerobic based fluid reactor, and another option is shown in FIG. 2 in the form of a Membrane Bio Reactor (MBR). In the MBR, instead of taking the cleanest water from the base of the fractionation chamber 16 to clarification, the water is taken from an immersed membrane system 15a. Equally a membrane aerated bioreactor or trickle system could use the foam fractionation features to improve the water quality for the cultures and partition PFAS.

As noted above, foam fractionation 16 is in a constant recycle loop with biological aerator 15, with 2.5× volume of aerator 15 being passed through fractionator 16 per hour in order to maintain an ORP that results in a highly efficient biological digestion in aerator 15. Fraction 16a is expected to have low concentrations of PFAS and may therefore be recycled to the primary digestion 13, and can be tuned such that a relatively high percentage (5-7% of inflow to 16) is recycled to digestion 13.

The fractionation stage 16 is employed principally to provide natural flotation where particles heavier than water are lifted to the surface with the help of air (or air/ozone), where they are skimmed off in ways similar to the removal of sludge from settling tanks. Its secondary function is the maintenance of ORP within the biological aeration stage 15, where waste O₃ from the ozofractionation is drawn by the fractionation venturis into the fractionation chamber 16 and, as it is in continual circuit with the biological stage 15, helps maintaining a high ORP during the biological aeration, which encourages healthy microbial cultures. Fractions 16a, made up of suspended solids and biological floc, are recycled to the anaerobic primary stage 13 as an activated sludge.

The discharge from the combined biological aeration 15 and foam fractionation 16 chambers is from the base of the foam fractionation 16, where the highest quality water from the stage develops before passing to either a final tertiary disinfection ozofractionation stage (not shown) to clarification or directly to clarification 17, depending on compliance regulations for the effluent.

Following its biological digestion 15/16, the wastewater is transferred to a clarifier 17, where the fractionated effluent quiesces in a settlement tank. It may be disinfected with an additional ozofractionation chamber (not shown) or be dosed with hypochlorite before discharging to the environment, depending on compliance regulations for the effluent. In some embodiments for example, the treated water may be disinfected 18, if such is required. As ozone is available, ozone can be utilised to disinfect rather than chlorine, although this will again depend on the level of disinfection required under local compliance conditions.

The final effluent is discharged from the process at 19. In embodiments where this process as a whole is within a managed property that discharges to sewer, the plant can be configured to remove PFAS to below background PFAS for a receiving sewer and clarification and disinfection will not be required.

Sludge developed from the activated sludge process will have a percentage of recycled ‘aged’ sludge that is sent back into process and a portion that will be directed to 20. Spent sludge 21 is treated to dewater and then managed as a biosolid for discharge to environment, either at a land fill or used in agricultural settings as a fertiliser (i.e. because it will contain no PFAS or microplastics, these having all been removed during the process described above)

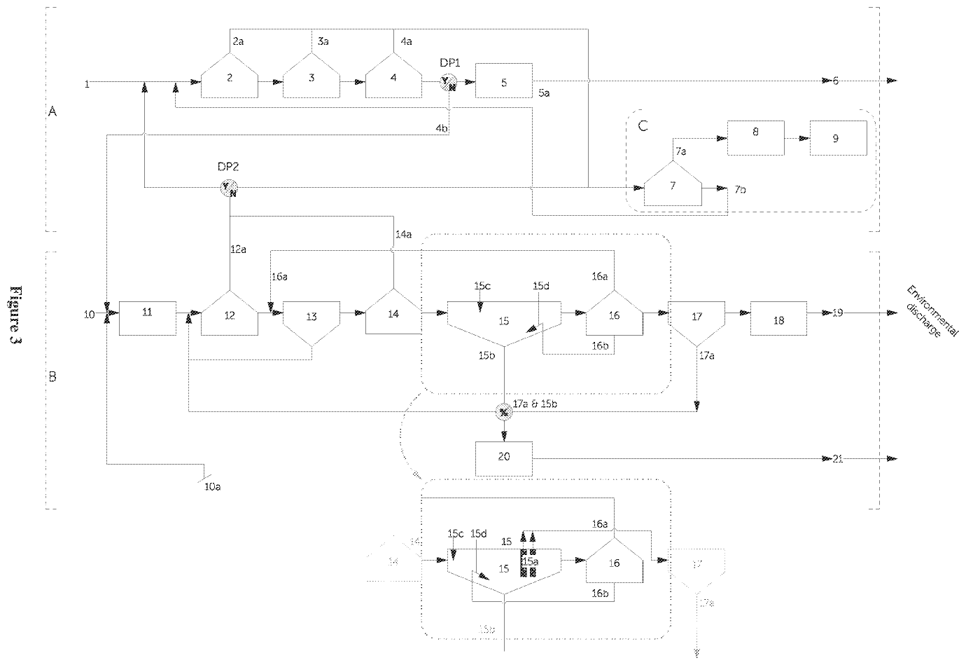

FIG. 3 is a block diagram of an embodiment of the second aspect of the present invention that describes the concept of a whole of site solution approach. In the block flow diagram, the treatment methods for Stream B (Sewer wastewater) is similar to that described above in the context of FIG. 1, but with the beneficial recycling and transfers between Stream A (PFAS impacted trade wastewater) and Stream B noted below.

In the Figure, an influent 1 from a PFAS impacted wastewater (i.e. a “Hot spot”) is introduced into the process for remediation. The source of PFAS impacted wastewater may, for example, be impacted surface, sewer, or ground waters, impacted seawater or impacted solvents.

The incoming PFAS impacted trade wastewater then undergoes a very aggressive primary ozofractionation 2, which produces a foam fraction 2a that contains approximately 1-3% (v/v) of the sewage but >99.97% of PFOS, PFOA, PFHxS and other long chain species that are attracted to the bubbles. The concentration of such persistent contaminants may be between 100 and greater than 1000× concentrated from influent concentration because ozofractionation aggressively partitions PFAS to fraction and converts oxidisable PFAS precursor compounds to PFAS species compatible with removal by fractionation. Oxidisable species that are oxidised are either removed to fraction 2a or remain in the ozofractionated fluid. Fraction 2a may be removed from the process for destruction, as described below.

The ozofractionated fluid from ozofractionation chamber 2 is then transferred to secondary ozofractionation chamber 3, where the remaining PFAS is reduced by a further >99% with respect to its inlet concentration, with further oxidation of species in the fluid occurring, which are either also removed to faction 3a or are carried over to either a NF/RO polish (not shown) or tertiary ozofractionation chamber 4, depending on polish method employed on site. The secondary fraction 3a is delivered to a common fraction launder (where it joins with fraction 2a), and usually contains >500× concentration of PFAS relative to the inlet concentration of chamber 3. Speciation of fraction shifts towards higher representation for shorter chain PFAS compounds. Approximately 0.5-1.5% of inflow to chamber 3 will report to fraction 3a.

The ozofractionated fluid from ozofractionation chamber 3 is then transferred to tertiary ozofractionation chamber 4, where the remaining PFAS is reduced by a further >99% with respect to its inlet concentration. Water chemistry, in particular pH and ORP may be adjusted to optimum conditions for the subsequent selected media type (e.g. an ion exchange resin). The tertiary fraction 4a is delivered to the common fraction launder (where it joins with fractions 2a and 3a), and usually contains 100 to greater than 500× concentration of PFAS relative to the inlet concentration of chamber 4. Approximately 0.5-1.5% of inflow to chamber 4 will report to fraction 4a.

PFAS speciation of the subsequent fraction shifts towards higher representation for shorter chain PFAS compounds unless a NF/RO polish is selected, in which case longer chains may also be present in the fraction as the NF/RO reject stream selects for remnant concentrations.

The ozofractionated fluid from ozofractionation chamber 4 may now be treated in two different ways. If the volume of ozofractionated fluid from ozofractionation chamber 4 is low enough to be able to be directed for continued remediation in combination with Stream B (Sewer waters), then the relatively low volume effluent is directed to the sewer influent 10 for co-remediation in Stream B (Sewage), as described below. However, if the volume of ozofractionated fluid from ozofractionation chamber 4 is relatively high, the effluent undergoes continued treatment in media polish 5.

Media polish 5 is selected based on what is deemed to be the best option for the site and may be IX resin, organo-silicates GAC or NF/RO. Alternatively, if compliance is for only PFOS, PFHxS & PFOA <0.07 μg/L it may be possible to have no media polish. Once polished, the remediated water is ready for discharge. This stage of the process will be determined by local compliance regulations and it may be necessary to batch test and discharge on proof of compliance in some jurisdictions. In the case where this process as a whole is within a managed property that is discharging to sewer, the plant can be configured to remove PFAS to below background PFAS for the receiving sewer. If discharge is to sewer then the output direct from ozofractionation chamber 4 could be directed to the sewer.

The combined fractionates 2a, 3a and 4a (usually about 1% of the contaminated influent volume) are passed to a final ozofractionation chamber 7. Ozofractionation 7 further concentrates the contaminants from the stream to create fraction 7a, the final fraction stream of approximately 3% of the influent volume into chamber 7 and approximately 0.02% of the influent volume into chamber 2. The ozofractionated fluid 7b from chamber 7 is recycled back to 1 PFAS contaminated influent. The final fraction concentration for PFAS is usually between 1000 to 10.000× the influent concentration, which is directed to vacuum reduction 8.

The vacuum reduction stage 8 utilises the excess vacuum available elsewhere in the process to allow the final fraction to be further reduced in volume by vacuum assisted dehydration. Waste heat is utilised from the process to elevate the temperature of the stage, allowing a reduction in volume of usually 75%. The batched output from this chamber is then delivered to the destruction stage 9, where final concentrate destruction (by technologies such as PFAS Harvester or Sonolysis), of the concentrate PFAS fraction permanently removes all PFAS from the environment.

As noted above, treatment of Stream B (sewage) may be substantially as described above with respect to FIG. 1, with the exception that the inflow 10 may be supplemented with the ozofractionated fluid from chamber 4, if the volume of that fluid is compatible with Stream B. Furthermore, the combined fractionates 12a and 14a may be recycled into Stream A, either at the beginning of the process, co-mixed with influent 1, where they undergo aggressive ozofractionation, or into ozofractionation chamber 7 (i.e. with the combined fractionates 2a, 3a and 4a) for concentration and destruction.

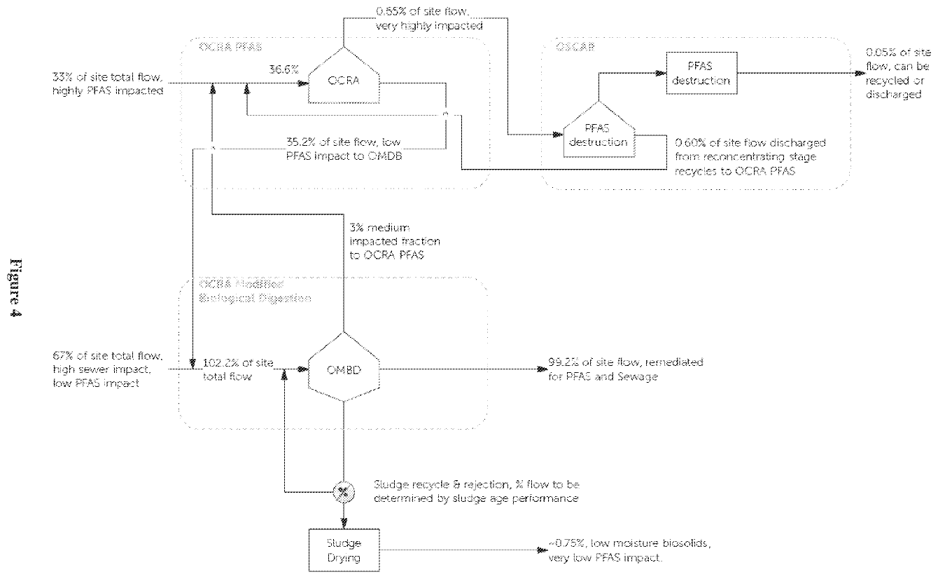

FIG. 4 is a simplified flowchart of an embodiment of the second aspect of the present invention, showing the relative proportions of the various fractions that are recycled and transferred throughout the methods.

Based on the footprints of water treatment systems the inventor has installed that can remediate a broad range of contaminated wastewaters, the following estimated plant footprints and specifications can be provided:

### Stream A—PFAS Waters

WTP footprint ˜200 m²
Estimated based on an influent volume ˜75 ML per day with variable ΣPFAS loading
Excludes influent and treated water tanks
Excludes storage shed for consumables and reagent
Excludes area for power pole or power generation
Excludes retention pondage for high flow weather events

### Stream B—Sewer Waters

WTP footprint 35% less than standard centralised sewer treatment plants (CSTP)
Estimated based a sewer load of ˜0.50 ML per day
Based on increased process efficiency due to delivery of higher oxygen rates to sludge
Based in reduction of sludge generation
Excludes waste bins

The final plant design and footprint will depend upon the percentage of non-sewer to sewer feed and the level of process redundancy required. Both systems can routinely handle shock loading which will reduce the requirement for long residence time and/or increases in media/reagent and media as compared to traditional systems.

The following equipment is likely to be required in order to process each stream.

### Stream A—PFAS Waters

Major equipment
Ozone generation system
Reaction vessels
Pumps
Pipework
Lighting
Access stair and/or ladders and handrails
PLC controller and automation equipment (actuated valves and small mechanical drives)

### Stream B—Sewer Waters

Major equipment
Screens & bins
Ozofractionation chamber
Clarifiers
Dosing pumps
Recirculation pumps
Filter pumps
Activated sludge vessels
Pumps
Pipework
Lighting
Access stair and/or ladders and handrails
PLC controller and automation equipment (actuated valves and small mechanical drives)

It is recommended that the PLC, operator controls and electrical circuits be housed in a dedicated building in order to provide year-round protection. The PFAS plant can be housed under an awning, whereas the sewer plant should be provided with a well ventilated and open aired space. Due to the use of ozone, odours will be kept at a minimum. While ozone is an odour suppressor, no free ozone will be allowed from the processes, with ozone detection equipment installed throughout to ensure operator safety.

As described herein, the present invention provides a method for remediating a wastewater comprising sewage and persistent contaminants. Embodiments of the present invention provide a number of advantages over existing remediation processes, some of which are summarised below:
ozofractionation surprisingly enhances biological activity, if conditions throughout the method are appropriately controlled;
the methods remove contaminants from the (solid and liquid) effluents of the biological digestions before they can become entrained therein, meaning that it is not necessity to remediate them before use; and
the proposed two-stream solution:
   minimises operating and capital costs, with partially treated wastewater from “Hot spots” being deliverable into the sewer having a lower contaminate concentrations than that of the sewage, instead of having to undergo final polishing,
   minimises the potential for cross-contamination of water types,
   minimises the generation of PFAS impacted waste material,
   maximises treatment efficiency and discharge compliance, and
   maximises flexibility to treat ‘shock loads’ to either system.

It will be understood to persons skilled in the art of the invention that many modifications may be made without departing from the spirit and scope of the invention. All such modifications are intended to fall within the scope of the following claims.

It will be also understood that while the preceding description refers to specific forms of the microspheres, pharmaceutical compositions and methods of treatment, such detail is provided for illustrative purposes only and is not intended to limit the scope of the present invention in any way.

It is to be understood that any prior art publication referred to herein does not constitute an admission that the publication forms part of the common general knowledge in the art.

In the claims which follow and in the preceding description of the invention, except where the context requires otherwise due to express language or necessary implication, the word “comprise” or variations such as “comprises” or “comprising” is used in an inclusive sense i.e. to specify the presence of the stated features but not to preclude the presence or addition of further features in various embodiments of the invention.

1. A method for remediating sewage that contains persistent contaminants, the method comprising:
ozofractionating the sewage under conditions whereby a foam fractionate comprising persistent contaminants is produced and separated from an ozofractionated wastewater;
quiescing the ozofractionated wastewater, whereby a residual ozone content of the ozofractionated wastewater is reduced to produce quiesced ozofractionated wastewater; and
contacting the quiesced ozofractionated wastewater with a microorganism population under conditions effective to biologically remediate the ozofractionated wastewater.

2. The method of claim 1, wherein the ozofractionating the sewage comprises exposing the sewage to an amount of ozone effective to increase the oxidation reduction potential (ORP) of the sewage to above about 750 mV.

3. The method of claim 1, wherein the ozofractionating the sewage comprises exposing the sewage to a foam of bubbles comprising ozone and having a size of less than about 200 μm.

4. The method of claim 1, wherein the ozofractionating the sewage comprises exposing the sewage to an amount of ozone of between about 5 mg/L/hour to about 150 mg/L/hour.

5. The method of claim 1, wherein the quiescing the ozofractionated wastewater comprises allowing the ozofractionated wastewater to quiesce for a period of time whereby substantially all of the residual ozone in the ozofractionated wastewater is utilised.

6. The method of claim 5, wherein the quiescing occurs during transfer of the ozofractionated wastewater to the microorganism population.

7. The method of claim 1, further comprising maintaining the microorganism population whereby it remains effective to continuously biologically remediate the ozofractionated wastewater.

8. The method of claim 1, wherein the ozofractionated wastewater is biologically remediated in an activated sludge process, a membrane bioreactor process or a membrane aerated bioreactor process.

9. The method of claim 1, wherein the ozofractionated wastewater is contacted with a first microorganism population in a primary biological digestion.

10. The method of 9, wherein an activated sludge which settles during the primary biological digestion is recycled back into a wastewater pre-ozofractionation.

11. The method of claim 9, further comprising treating the wastewater after the primary biological digestion to increase the ORP of the wastewater before further biological remediation.

12. The method of claim 9, further comprising a secondary ozofractionation of the wastewater after the primary biological digestion, the secondary ozofractionation being under conditions effective to increase the ORP of the wastewater and convert species in the wastewater into species that are more conducive to aerobic biodegradation.

13. The method of claim 12, wherein the secondary ozofractionation comprises exposing the wastewater to an amount of ozone effective to increase the oxidation reduction potential (ORP) of the wastewater to between about 150 mV to about 200 mV.

14. The method of claim 12, wherein the secondary ozofractionation comprises exposing the wastewater to an amount of ozone of about 0.5 mg/L/hour to about 5 mg/L/hour.

15. The method of claim 1, further comprising a final ozofractionation in which the biologically remediated wastewater is ozofractionated again under conditions whereby particulate material is captured in a foam fractionate for separation, and a portion of the re-ozofractionated wastewater is recycled back into the microorganism population.

16. A method for co-remediating sewage that contains persistent contaminants and a trade wastewater that contains the persistent contaminants, the method comprising:
ozofractionating the trade wastewater under conditions whereby a foam fractionate comprising persistent contaminants is produced and separated from an ozofractionated trade wastewater which contains an amount of the persistent contaminants that is about the same as or less than an amount of the persistent contaminants contained in the sewage;
mixing the ozofractionated trade wastewater into the sewage to produce a combined wastewater;
ozofractionating the combined wastewater under conditions whereby a foam fractionate comprising persistent contaminants in the combined wastewater is produced and separated from an ozofractionated combined wastewater;
quiescing the ozofractionated combined wastewater, whereby a residual ozone content of the ozofractionated combined wastewater is reduced to produce a quiesced ozofractionated combined wastewater; and
contacting the quiesced ozofractionated combined wastewater with a microorganism population under conditions effective to biologically remediate the quiesced ozofractionated combined wastewater.

17. The method of claim 16, wherein the ozofractionating the trade wastewater comprises multiple ozofractionations, each subsequent ozofractionation further reducing the amount of the persistent contaminants contained in each subsequent ozofractionated trade wastewater.

18. The method of 16, wherein the ozofractionation(s) are carried out until the amount of the persistent contaminants contained in the ozofractionated trade wastewater is about half of the amount of the persistent contaminants contained in the sewage.

19. The method of claim 16, wherein the ozofractionating the trade wastewater comprises exposing the wastewater to an amount of ozone effective to increase the oxidation reduction potential (ORP) of the wastewater to above about 750 mV.

20. The method of claim 16, wherein the ozofractionating the trade wastewater that contains persistent contaminants comprises exposing the wastewater to a foam of bubbles comprising ozone and having a size of less than about 200 μm and/or exposing the wastewater to an amount of ozone of between about 50 mg/L/hour to about 150 mg/L/hour.
